(19) United States
(12) Patent Application Publication
(10) Pub. No.: US 2022/0151258 A1
(43) Pub. Date: May 19, 2022

(54) Protein Hydrolysate, Method for Making, and Use

(71) Applicants: Michael J. Young, Kimberly, ID (US); Loren S. Ward, Twin Falls, ID (US)

(72) Inventors: Michael J. Young, Kimberly, ID (US); Loren S. Ward, Twin Falls, ID (US)

(21) Appl. No.: 17/592,412

(22) Filed: Feb. 3, 2022

Related U.S. Application Data
(63) Continuation of application No. 15/284,368, filed on Oct. 3, 2016, now abandoned.
(60) Provisional application No. 62/236,842, filed on Oct. 2, 2015.
(60) Provisional application No. 62/304,354, filed on Mar. 7, 2016.

(51) Int. Cl. A23J 1/20; A23J 3/34; A23C 21/02; A23C 19/082; A23C 9/142; A23C 19/02; A23J 3/14

(52) U.S. Cl. CPC A23J 1/205; A23J 3/343; A23C 21/02; A23C 19/082; A23V 2002/00; A23J 3/346; A23C 19/02; A23J 3/14; A23C 9/142

(57) ABSTRACT

Disclosed is a method for recovering protein hydrolysates from high-fat protein concentrates. The method can be used, for example, to produce a whey protein hydrolysate from the by-product retentate of the manufacture of whey protein isolates, as well as to isolate the milk fat globule membrane from a high-fat whey protein concentrate starting material.

### FIELD OF THE INVENTION

The invention relates to a method for producing a protein hydrolysate. More specifically, the invention relates to a method for producing a protein hydrolysate from protein concentrate, especially a higher-fat protein concentrate by-product of the manufacture of a protein isolate.

### BACKGROUND OF THE INVENTION

High-fat protein concentrates (HFPCs) have a distinctive protein profile that has typically made them a “lower quality” product than their lower-fat counterparts because, being a byproduct of microfiltration to separate fat and protein, they have already been through a filtration process that separates protein from fat—these proteins being the ones that remained with the fat when the membrane was selected to separate the fat and allow the proteins through as permeate. These protein concentrates have had limited usefulness. For example, protein hydrolysates are not generally made using these HFPCs. HFPCs can be produced during isolation processes used for proteins of animal and/or vegetable origin.

For example, bovine whey contains approximately 1% protein. It is separated from milk during cheese processing and is concentrated to make whey protein concentrates (WPC) or whey protein isolates (WPI). WPC is generally considered to contain protein in the range of from about 35 to about 80%. Some sources indicate that a product is still a WPC if the protein content goes as high as 89%, but in practice it is difficult to achieve levels higher than about 80% when the retentate contains as much fat as is commonly found in WPCs. The higher-protein products from which almost all the fat has been removed are referred to as whey protein “isolates” (WPIs). The term “concentrate” refers to the fact that the protein level of WPC is significantly higher than that of the whey from which it was derived, and it contains other components, such as lactose and fat. The term “isolate” refers to the fact that the protein level of WPI is significantly higher than that of a concentrate, and the protein has also been isolated so that there is very little remaining lactose, fat, etc. Whey proteins include p-lactoglobulin (p-LG), a-lactalbumin (a-LA), glycomacropeptide (if made from sweet whey), immunoglobulins, lactoferrin, and bovine serum albumin. Casein and fragmented casein residues, as well as minor whey proteins (e.g., lactoferrin, lactoperoxidase, growth factors, etc.) are also present in small quantities.

Filtration traditionally has been used in the dairy industry for removing bacteria, defatting whey, and enriching casein (micellar casein) in cheese-making. Filtration is also used for the fractionation of caseins and whey proteins from milk, since most caseins in milk are found in casein micelles that are large, spherical, stable complexes of casein which are larger in molecular weight than whey proteins because whey proteins have limited self-association characteristics in milk, and therefore tend not to form aggregates. The larger molecules that are retained in the membrane are referred to as the “retentate,” and the smaller molecules that pass through the membrane are referred to as the “permeate.”

Microfiltration is one of the methods by which whey protein isolate is manufactured. Microfiltration retains fat found in the whey while allowing the whey protein, lactose and some minerals to pass into the permeate. The permeate is further filtered using ultrafiltration to remove lactose and some of the minerals, to obtain a finished product that has >90% protein on a dry matter basis and less than 1% fat on a dry matter basis.

Ultrafiltration, developed in the late 1970's, is often used to convert whey to whey protein concentrates. Whey protein concentrate 80 (containing 80% protein on a dry matter basis) is manufactured by extensive ultrafiltration and diafiltration of crude whey to reduce the non-protein components, especially the lactose content. According to the U.S. Dairy Export Council, commercial whey protein concentrate 80 (WPC80) typically contains about 80 to 82% protein, 4 to 8% lactose, 3 to 4% ash, 3.5 to 4.5% moisture, and 4 to 8% fat, while whey protein isolate typically contains 90.0%-92.0% protein, 0.5%-1.0% lactose, 0.5%-1.0% fat, 2.0%-3.0% ash, and 4.5% moisture (Reference Manual for U.S. Whey and Lactose Products, USDEC (2008), p. 33). Typical compositions of WPCs of varying protein levels produced are shown in Table 1.

TABLE 1

| | | | | |
|---|---|---|---|---|
| Protein in dry matter | 35 | 50 | 65 | 80 |
| Moisture | 4.6 | 4.3 | 4.2 | 4.0 |
| Crude Protein | 36.2 | 52.1 | 63.0 | 81.0 |
| True Protein | 29.7 | 40.9 | 59.4 | 75.0 |
| Lactose | 46.5 | 30.9 | 21.1 | 3.5 |
| Fat | 2.1 | 3.7 | 5.6 | 7.2 |
| Ash | 7.8 | 6.4 | 3.9 | 3.1 |
| Lactic Acid | 2.8 | 2.6 | 2.2 | 1.2 |

To produce WPC80 concentrate, liquid whey is first concentrated 20× to 30× by ultrafiltration, giving a solids content of about 25%. The concentrate is then processed by diafiltration (adding water to the feed during filtration) to wash out lactose and ash (minerals).

Whey protein concentrates may also be made by using the retentate from whey protein isolate manufacturing. The microfiltration process produces a permeate, containing the defatted whey protein (WPI), and a retentate which contains milk fat globule membranes (MFGM), residual fat, minerals and residual protein that did not permeate through during microfiltration. The WPI (MF permeate) undergoes further processing to concentrate the protein, and is then spray-dried before packaging. The retentate may also be further ultrafiltered to remove lactose and some minerals and then dried, producing a high-fat WPC powder (HFWPC). It should be noted that unlike the protein in the WPC product, which is collected as a retentate using a membrane that is selected to retain the protein, the protein that remains with the HFWPC product is collected in the retentate using a membrane that is selected to allow the protein to pass through in the permeate. The HFWPC protein must therefore have certain properties that distinguishes it from the WPC protein. The WPC and HFWPC products therefore differ in both the fat content and the protein in the products.

Milk fat triglycerides form globules. The globules are surrounded by a protein and phospholipid membrane (the milk fat globule membrane) that stabilizes the globules in the serum (water) phase of milk. The residual lipid fraction in both WPC and HFWPC comes from fragments of milk fat globule membrane (MFGM) and very tiny intact fat globules. These small, stable colloidal particles remain in the whey after clarification. The MFGM fragments are further concentrated and retained with the protein during manufacture of both WPC80 and HFWPC80.

The increased protein concentration, decreased fat content, and decreased lactose content of WPI has made it a very desirable product for use in performance nutrition and other products which utilize whey protein as a key ingredient. As shown in FIG. 1, the price per pound for whey protein isolate is significantly higher than that for whey protein concentrate, and for the past few years the difference in price has been becoming more pronounced. Defatted protein and defatted protein hydrolysate are more attractive options for many of the uses for whey protein, in part because the reduction in fat causes a concomitant reduction in cholesterol. Whey protein hydrolysates (WPH) generally command an even higher price than does WPI.

Whey protein hydrolysates may be produced from either WPCs or whey protein isolates. Various methods have been described for producing hydrolysates from WPCs made directly from whey, the protein being collected as retentate during filtration. For example, Nielsen et al. (WO 92/21248) described a method comprising the steps of hydrolyzing the protein and filtering the hydrolysate to collect the hydrolyzed protein in the permeate and discard the retentate. Hydrolysis was generally performed at pH 8.0 for a period of 12 hours, and the resulting hydrolysate comprised a protein content of about 84-85%. In one example, a protein content as high as 89.5% was achieved in the final product by adding a nanofiltration step to the process to further concentrate the protein of the retentate. Similarly, O'Callaghan et al. (WO 93/04593) disclose a method that comprises the steps of hydrolyzing WPC80 at pH 8.0 for a period of 5-6 hours, then collecting the hydrolysate as a permeate from microfiltration. The protein content of the resulting product was 77.15%.

These methods have demonstrated that protein hydrolysates can be produced from WPCs, with a significant reduction of fat in the permeate hydrolysate. However, the higher fat content and distinctive protein profile of HFWPCs have made them a “lower quality” product from which hydrolysates are not generally made because, being a byproduct of microfiltration to separate fat and protein, they have already been through a filtration process that separates protein from fat—these proteins being the ones that remained with the fat when the membrane was selected to separate the fat and allow the proteins through as permeate. The protein a HFWPC contains could, if isolated from the MFGM and fat, be both nutritionally and commercially valuable. Furthermore, if sufficiently isolated, the MFGM may itself be a valuable product, as a variety of beneficial physiological effects have been associated with MFGM. It would therefore provide a significant advantage in the industry if methods were developed for utilizing HFPCs as a source of hydrolysates, optimizing the recovery of protein from HFWPCs, for example, and increasing the purity of the milk fat globule membrane fraction that can be isolated from HFWPCs. It would also be advantageous if such methods could also be more broadly applied to other food proteins such as, for example, pea and/or other animal and/or vegetable proteins.

### SUMMARY OF THE INVENTION

The invention relates to a method for producing a protein hydrolysate from at least one high-fat protein concentrate, the method comprising the steps of (a) heating an about 5 to about 40 percent w/v solution of a high-fat protein concentrate having a protein content of at least about 34 percent to a temperature of from about 90 to about 125 degrees Fahrenheit; (b) hydrolyzing the protein, by adding at least one proteolytic enzyme to the solution, for a period of from about 1 hour to about 12 hours; (c) Isolating the hydrolyzed protein by filtering the solution to produce a permeate and a retentate, wherein the hydrolyzed protein is collected in the permeate as a hydrolyzed protein product (i.e., protein hydrolysate).

In various aspects of the Invention, the method may also include the following steps (d) hydrolyzing the protein remaining in the retentate using at least one proteolytic enzyme for a period of from about 1 hour to about 12 hours to produce a second hydrolyzed protein product; (e) Isolating the second hydrolyzed protein product by filtration of the retentate (i.e., the “first retentate”) to produce a second permeate and a second retentate, wherein the second hydrolyzed protein product is collected in the second permeate as a second protein hydrolysate; and (f) combining the first protein hydrolysate with the second protein hydrolysate; wherein the hydrolyzed protein of step (c) is the first protein hydrolysate.

In various embodiments, the invention also relates to a method for producing protein hydrolysates from high-fat protein concentrates derived as a by-product of the manufacture of protein Isolates, the method comprising the steps of (a) hydrolyzing a first protein fraction in a high-fat protein concentrate using at least one proteolytic enzyme to produce a first hydrolyzed protein product; (b) separating the first hydrolyzed protein product from the high-fat protein concentrate; (c) hydrolyzing a second protein fraction which remained with the high-fat protein concentrate after the step of separating the first hydrolyzed protein product from the high-fat protein concentrate, using at least one proteolytic enzyme to produce a second hydrolyzed protein product; and (d) separating the second hydrolyzed protein product from the high-fat protein concentrate. In various aspects of the invention, a step (e) can be added, that is, combining the first hydrolyzed protein product with the second hydrolyzed protein product. Combining the two hydrolyzed protein products produces a protein hydrolysate of excellent quality that may be used in a variety of applications.

The invention also relates to a method for isolating a milk fat globule membrane (MFGM) fraction from high-fat whey protein concentrate, the method comprising the steps of (a) heating an about 5 to about 40 percent w/v solution of a high-fat whey protein concentrate having a protein content of at least about 34 percent to a temperature of from about 90 to about 125 degrees Fahrenheit; (b) hydrolyzing the protein using at least one proteolytic enzyme for a period of from about 1 hour to about 12 hours; (c) Isolating the hydrolyzed protein by filtering the solution to produce a permeate and a retentate, wherein the milk fat globule membrane fraction is collected in the retentate.

In various aspects of the invention, the method can additionally comprise one or more steps of adjusting the pH of the solution. The step of Isolating the hydrolyzed protein by filtration can be performed using at least one filter membrane of pore size of from about 10 kilo Daltons (kDa) to about 500 kDa, and/or utilizing microfiltration (0.1-0.45 um).

In various aspects, the method of the invention can also include one or more steps of diafiltration to concentrate a retentate produced by from a filtration step.

The protein can be one or more proteins of plant and/or animal origin such as, for example, pea proteins and/or milk proteins (e.g., bovine milk proteins). In various aspects, the protein can comprise whey protein concentrate, denatured WPC, evaporated WPC, or other higher-fat product such as those associated with whey processing by microfiltration, ultrafiltration, or Ion-exchange.

### BRIEF DESCRIPTION OF THE DRAWINGS

FIG. 1 is a line graph illustrating the difference in per-pound pricing over a thirteen month period, from August 2014 to August 2015, between whey protein isolate (upper line) and whey protein concentrate (lower line).

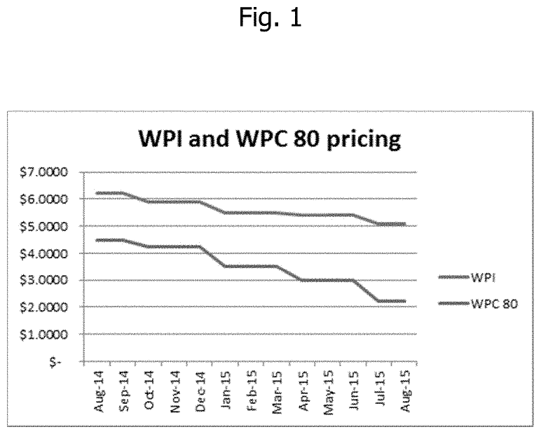

### DETAILED DESCRIPTION

The inventors have developed a method for recovering protein hydrolysates from high-fat protein concentrates (HFPC) such as those derived from the by-product retentate of the manufacture of whey protein isolates. When protein isolates are made from protein concentrates, a by-product protein concentrate is produced which contains significant amounts of fat. When whey protein concentrate is the starting material, the resulting by-product protein concentrate is a high-fat whey protein concentrate (HFWPC) that contains significant amounts of milk fat globule membrane (MFGM). The inventors' method comprises the steps of hydrolyzing a high-fat whey protein concentrate (HFWPC) using at least one proteolytic enzyme to produce a protein hydrolysate, filtering the protein hydrolysate to produce a permeate and a retentate, and collecting the permeate comprising hydrolyzed protein. More specifically, the method can comprise the steps of heating an about 5 to about 40 percent w/v solution (optimum range has generally been found by the inventors to be from about 13 to about 17 percent) of a protein starting material having a protein content of at least about 34 percent to a temperature of from about 90 to about 125 degrees; hydrolyzing the protein using at least one proteolytic enzyme for a period of from about 1 hour to about 12 hours; Isolating the hydrolyzed protein by filtration to produce a permeate and a retentate, wherein the hydrolyzed protein is collected in the permeate as a hydrolyzed protein product (i.e., protein hydrolysate).

As used herein, the abbreviation “WPC” is intended to denote a whey protein concentrate that is produced by filtration of the whey fraction from milk. The abbreviation “HFWPC,” on the other hand, is intended to denote a whey protein concentrate that is produced by collecting the retentate from whey protein isolate (WPI) processing, wherein the WPI is collected as the permeate. The two products, although both referred to as whey protein concentrates, differ in both fat content and in the properties of the proteins in them. WPCs contain significant levels of proteins that, for the most part, can readily be separated from the MFGM and small fat globules, while HFWPC proteins are more challenging to separate using filtration and remain associated with the MFGM and fat globules after microfiltration. It will be recognized by those of skill in the art that the term “protein” is interchangeably used by those of skill in the art to mean a single protein molecule or a quantity of protein molecules, whether they be molecules of the same protein or a mixture of molecules of different proteins. Therefore, those of skill in the art generally interpret the term in the context in which it is used. For example, whey protein is a mixture of molecules of different proteins which remain in the whey fraction derived from milk. Where ranges are indicated herein, those ranges should be considered to include sub-ranges thereof (i.e., from about 5 to about 40 will include from about 5 to about 20, from about 5 to about 10, from about 10 to about 20, from about 10 to about 40, etc.).

The inventors have also discovered that more than one round of hydrolysis (i.e., “sequential hydrolysis”) of the retentate can be used to increase the amount of protein recovered from the HFWPC. In fact, this type of sequential hydrolysis can also be used to increase the amount of protein recovered when producing hydrolyzed whey protein from WPC. For example, a method for sequential hydrolysis of HFWPC to produce a hydrolyzed whey protein comprises the steps of (a) heating an about 5 to about 40 percent (w/v) solution of a high-fat whey protein concentrate having a protein content of at least about 34 percent to a temperature of from about 90 to about 125 degrees Fahrenheit; (b) hydrolyzing the protein using at least one proteolytic enzyme for a period of from about 1 hour to about 12 hours to produce a first hydrolyzed protein; (c) isolating the hydrolyzed protein by filtering the solution to produce a first permeate and a first retentate, wherein the first hydrolyzed protein is collected in the first permeate as a first hydrolyzed protein product; (d) hydrolyzing the protein remaining in the first retentate using at least one proteolytic enzyme for a period of from about 1 hour to about 12 hours to produce a second hydrolyzed protein; (e) isolating the second hydrolyzed protein by filtering the first retentate and collecting in a second permeate from the filtration a second hydrolyzed protein product; and optionally, (f) combining the first hydrolyzed protein product with the second hydrolyzed protein product to produce a protein hydrolysate. In various aspects of the invention, the method can additionally comprise one or more steps of adjusting the pH of the solution to optimize the action of the enzyme on the specific type of protein. Hydrolyzing the protein remaining in the retentate may be done by adding at least one proteolytic enzyme to the retentate, and/or a solution made with the retentate (i.e., retentate solution) and incubating to allow hydrolysis to proceed for a period of from about 1 to about 12 hours.

As shown in Tables 2, 3 and 4 below, sequential hydrolysis (results shown in tables 3 and 4) can provide a significant increase in the ultimate recovery of protein from a starting material, especially a starting material such as whey protein concentrate which comprises not only protein, but also carbohydrates (i.e., lactose) and fats (i.e., MFGM and fat globules). The protocols associated with these results are described in the Examples. In each case, the protein hydrolysate was collected in the permeate and concentrated by diafiltration. For the sequential hydrolysis procedure (3 hours+3 hours), the two resulting permeates were combined. As one can see from Tables 2, 3 and 4, although the total hydrolysis time may be the same, performing the hydrolysis using sequential hydrolysis steps as in the method of the invention produces a significant increase in the protein recovery from the starting material. At a cost in excess of 5 U. S. dollars per pound, this can represent a very significant economic advantage in the industry.

“Pressure-driven” membrane processes include microfiltration (MF), ultrafiltration (UF), and nanofiltration (NF). The driving force for separation in these processes is transmembrane pressure (TMP), the pressure difference between the retentate side and permeate side. Material applied to a membrane separation system is separated into retentate (the fraction that is retained by the membrane) and permeate (the fraction that passes through the membrane). The products of interest can either be in the retentate or in the permeate, or in both. In the method of the invention, the filtration step can be performed using ultrafiltration or microfiltration, for example. The pore size of a filter membrane can comprise from about 10 kDa to about 500 kDa. The protein fraction is collected as a permeate and the MFGM fraction is collected as a retentate. In various aspects, the invention can also include one or more steps of diafiltration to concentrate the first and/or second (and/or subsequent) retentate(s) produced by the method.

Filtration equipment, filter membranes, and enzymes suitable for use in the method of the Invention are commercially available, and known to those of skill in the art within the food processing Industry. The filtration equipment and membranes should generally be selected for their ability to process large volumes of whey protein concentrates and/or MF retentates. Suitable ultrafiltration units are available from Tetrapak, GEA, and Alfa Laval, for example, and suitable membranes for ultrafiltration are available from Koch, GE, Snyder, and Pall. Enzymes may be obtained from suppliers such as Danisco®, for example.

The Invention Includes compositions made by the methods disclosed herein. Various embodiments of the method of the Invention disclosed herein can be used to produce a whey protein hydrolysate that is similar in composition to that produced by the hydrolysis of whey protein isolate—i.e., a defatted, high-protein hydrolysate. Hydrolyzed whey protein is used in products sold in the performance nutrition, food, beverage, infant formula, enteral nutrition, and other markets, and is highly valued for its digestibility and bioavailability. Hydrolyzed whey protein is typically produced by enzymatic hydrolysis, which is described herein, but is not intended to be limited solely to enzymatic hydrolysis, as other methods for hydrolyzing protein are known to those of skill in the art. However, enzymatic hydrolysis is, for reasons known to those of skill in the art, preferable to produce optimal results.

The invention also provides a method by which milk fat globule membrane (MFGM), which is present at higher levels in HFWPC than in either WPC or WPI, can be isolated. In whole milk, the fat globules are surrounded by a protein and phospholipid membrane (the milk fat globule membrane) that stabilizes the globules in the serum phase of the milk. The residual lipid fraction in WPC80 and HFWPC80 comes from fragments of milk fat globule membrane (MFGM) and very tiny intact fat globules. These MFGM fragments and fat globules are generally not removable by centrifugation or other means by which the larger, intact fat globules may be removed. Filtration means, such as ultrafiltration, for example, provide a method by which the MFGM may be isolated. However, it should be apparent to one of skill in the art that the more protein that remains in the retentate following hydrolysis and filtration of a whey protein concentrate starting material, the greater is the impurity level of the MFGM fraction that remains with the retentate. The method of the invention provides a means by which the level of whey protein remaining with the retentate fraction after filtration can be reduced, thereby increasing the percentage of MFGM in the retentate fraction (and therefore the purity of the resulting MFGM product). MFGM isolated by the method of the invention may be further processed by collecting the retentate and using it as a starting material for further purification of MFGM components that have functional or nutritional characteristics that are deemed desirable.

Products produced by the method of the invention have nutritional and physiological importance. For example, whey protein contains calcium-binding peptides that can form complexes with calcium to improve its absorption and bioavailability (Huang, S. L. et al. Purification and characterisation of a glutamic acid-containing peptide with calcium-binding capacity from whey protein hydrolysate, J Dairy Res. 2015 February; 82(1):29-35). Peptides derived from whey protein have inhibitory effects on angiotensin-l-converting enzyme (ACE) (Fitzgerald, R. J. and Meisel, H. Lactokinins: whey protein-derived ACE inhibitory peptides. Nahrung. 1999 June; 43 (3):165-7. Whey protein hydrolysates have been reported to be a good natural source of antioxidant peptides (Zhang, X. Q. et al. Isolation and identification of antioxidant peptides derived from whey protein enzymatic hydrolysate by consecutive chromatography and Q-TOF MS. J Dairy Res. 2013 August; 80(3):367-73.). Whey protein hydrolysates have been shown to be more effective for use in enteral diets than are free amino acids (Boza, J. J. et al. Protein hydrolysate vs free amino acid-based diets on the nutritional recovery of the starved rat. Eur J Nutr. 2000 December; 39(6):237-43). Dietary MFGM supplementation combined with regular exercise improves skeletal muscle strength (Soqa, S., et al. Dietary milk fat globule membrane supplementation combined with regular exercise improves skeletal muscle strength in healthy adults: a randomized double-blind, placebo-controlled, crossover trial. Nutr J. 2015 Aug. 25; 14(1): 85). Components of the milk fat globule membrane have been suggested to have anti-cancer benefits, cholesterol-lowering effects, and anti-bacterial effects (Spitzburg, V. L. Invited Review: Bovine Milk Fat Globule Membrane as a Potential Nutraceutical. J. Dairy Sci. 88:2289-2294). Results of at least one study indicate that MFGM supplementation to infant formula narrows the gap in cognitive development between breastfed and formula-fed infants (Timby, N., et al. Neurodevelopment, nutrition, and growth until 12 mo of age in infants fed a low-energy, low-protein formula supplemented with bovine milk fat globule membranes: a randomized controlled trial. Am J Clin Nutr. 2014 April; 99(4):860-8).

Separation of the protein from the MFGM and associated tiny fat globules provides the additional advantage of removing cholesterol from the HFWPC-derived whey protein isolate.

Products made by the method of the invention may be spray-dried, freeze-dried, or used as a liquid base in beverages or other food applications and can be used in a variety of supplements, ingredients for food and drink formulations, etc. Powdered products may be made by collecting the diafiltered permeate and drying the protein using methods such as, for example, spray-drying, evaporation, freeze-drying, or other drying techniques known to those skilled in the art of producing protein powders. These powdered hydrolyzed protein products may be used as stand-alone supplements, or as ingredients in products such as nutritional bars, beverages, supplements, medical foods, infant formulas, and bakery products.

The inventors have discovered that an HFWPC retentate (HFWPC-R) (i.e., a milk fat globule membrane ingredient) produced by the method of the invention can be used to produce cheese products, especially, for example, processed cheeses, having decreased hardness, as well as having decreased viscosity when the cheese is melted. Residual protein in the HFWPC-R can fortify cheese products to which the HFWPC-R is added, and the inventors have discovered that by using the HFWPC-R protein fortification can be accomplished without the usual increase in cheese hardness that has been associated with the addition of protein to processed cheese. Use of HFWPC-R can also reduce the need to add anhydrous milk fat (milk fat from fresh cream), which can result in a significant cost savings under certain market conditions. Processed cheeses produced using an HFWPC-R of the invention can provide the improved qualities desired for certain uses of processed cheese, for example, such as improved melting properties for cheese dips (e.g., queso), quesadillas, and grilled cheese sandwiches.

The invention may be further described by the following non-limiting examples.

### EXAMPLES

### Example 1

Concentrated HFWPC 80 was added to water to make a 15% (w/v) solution. The solution was heated to 50° C. and pH was adjusted using 1 M KOH to a pH of 7.0. Enzyme HYW 20 (Danisco®) was added at 0.5% of total solids and hydrolysis was maintained for a period of 6 hours at 50° C. and pH 7. Microfiltration was performed using a membrane with a pore size of 100 kilo Daltons (100 kDa). The solution was first concentrated, then diafiltered with water to perform a 3× diafiltration. The permeate was collected as the hydrolyzed protein product and the retentate was collected as a high fat product (HFWPC-R), including a fraction provided by the milk fat globule membrane. Total protein in the initial HFWPC 80 concentrate was initially 234 grams. The hydrolyzed protein in the permeate was 164.5 grams with a protein dry matter basis (dmb) of 84.5%. 69.5 grams of protein remained in the retentate, with a protein dmb of 64.6%, as shown in Table 2.

TABLE 2
6-hour Hydrolysis, Single Microfiltration Step

| | Protein dmb (%) | Protein (grams) | % of total |
|---|---|---|---|
| Starting material | 78 | 234 | 100 |
| MF permeate | 84.5 | 164.5 | 70.3 |
| MF retentate | 64.6 | 69.5 | 29.7 |

### Example 2

Concentrated HFWPC 80 was added to water to make a 15% solution and the solution was heated to 50° C. pH was adjusted using 1 M KOH to a pH of 7.0 and enzyme HYW 20 (Danisco®) was added at 0.25% of total solids. Hydrolysis was maintained for a period of 3 hours, maintaining temperature at 50° C. and pH at 7. Microfiltration was performed using a membrane with a pore size of 100 kilodaltons and the solution was first concentrated then diafiltered with water to perform a 1× diafiltration. The hydrolyzed product was collected in the permeate and the retentate was collected and further hydrolyzed by adding additional Enzyme HYW 20 at 0.25% of total solids. Hydrolysis was maintained for a period of 3 hours at 50° C. and pH 7. Microfiltration was performed using a membrane with a pore size of 100 kilodaltons and the solution was first concentrated then diafiltered with water to perform a 1× diafiltration. The hydrolyzed product was collected in the permeate and the high fat product was collected in the retentate. Total Initial protein was 208.3 grams, with 160 grams going to the permeate (protein dmb of 85.8%) as hydrolyzed protein and 48.3 grams (protein dmb of 55.5%) protein remaining with the retentate, as shown in Table 3.

TABLE 3
3 + 3-hour Hydrolysis, Two Microfiltration Steps
pH Adjustment Throughout Hydrolysis

| | Protein dmb (%) | Protein (grams) | % of total |
|---|---|---|---|
| Starting material | 78 | 208.3 | 100 |
| MF permeate | 85.8 | 160 | 76.8 |
| MF retentate | 55.5 | 48.3 | 23.2 |

### Example 3

Concentrated HFWPC 80 was added to water to make a 15% solution, which was heated to 50° C. and pH-adjusted to 7.0 using 1 M KOH. Enzyme HYW 20 was added at 0.25% of total solids and hydrolysis was maintained for a period of 3 hours at 50° C. without pH adjustment. Microfiltration took place on a membrane with a pore size of 100 kilodaltons and solution was first concentrated then diafiltered with water to perform a 1× diafiltration. The hydrolyzed product was collected as permeate and the retentate was collected and further hydrolyzed by adjusting pH to 7 using 1 M KOH and adding additional Enzyme HYW 20 at 0.25% of total solids. Hydrolysis was maintained for a period of 3 hours at 50° C. and microfiltration was performed using a membrane with a pore size of 100 kilodaltons and the solution was first concentrated then diafiltered with water to perform a 1× diafiltration. The hydrolyzed product was collected as permeate and the high fat product was collected as retentate. Total Initial protein was 201.3 grams, with 155.4 grams hydrolyzed protein (dmb of 88.9%) going to the permeate and 45.9 grams protein (dmb of 58.4%) remaining with the retentate, as shown in Table 4.

TABLE 4
3 + 3-hour Hydrolysis, Two Microfiltration Steps, w/o
pH Adjustment Throughout Hydrolysis

| | Protein dmb (%) | Protein (grams) | % of total |
|---|---|---|---|
| Starting material | 78 | 201.3 | 100 |
| MF permeate | 88.9 | 155.4 | 77.2 |
| | 58.4 | 45.9 | 22.8 |

### Example 4—Production of Processed Cheese Using High-fat WPC Retentate

Three products were made, using different WPC ingredients—(1) conventional WPC at 70% protein, (2) HFWPC-R-1 (71% protein), and (3) HFWPC-R-2 (58% protein). Briefly, cheese and butter were added to the process cooker and the augers were set to rotate at 150 rpm. Indirect steam was applied at 399 degrees Fahrenheit. Dry ingredients and water were added at 2 min 30 seconds. Mixing and heating continued, with the temperature reaching 175 degrees Fahrenheit before the product was discharged and packaged. Packaged product was stored under refrigeration. The Ingredients of the product(s) are shown in Table 5 below.

TABLE 5
Processed Cheese Product Ingredients

| | % | grams |
|---|---|---|
| Young Cheese (<2 months) | 72.07 | 2612.69 |
| Butter | 4.38 | 158.76 |
| Water | 9.98 | 362.00 |
| Salt | 0.41 | 15.00 |
| WPC | 9.98 | 362.00 |
| Trisodium Phosphate | 0.99 | 36.00 |
| Disodium Phosphate | 1.99 | 72.00 |
| 88% w/w lactic Acid | 0.19 | 7.00 |

Comparison of Ingredients (moisture, lactose, protein, ash, and lipid) of the three processed cheese products is shown in Table 6.

TABLE 6

| | WPC | HFWPC-R-1 | HFWPC-R-2 |
|---|---|---|---|
| Moisture | 4.5% | 4.5% | 4.5% |
| Lactose | 3.5% | 0.03% | 0.0% |
| Protein | 70% | 71.3% | 58.3% |
| Ash | 2.4% | 2.8% | 5.3% |
| Lipid | 12% | 21.5% | 39.3% |

Comparison of properties of the three processed cheese products is shown in Table 7.

TABLE 7

| | WPC | HFWPC-R-1 | HFWPC-R-2 |
|---|---|---|---|
| Moisture | 36.57% | 36.03% | 36.56% |
| Fat | 30.86% | 31.00% | 31.89% |
| Salt | 1.72% | 1.79% | 1.67% |
| FDB | 48.65% | 48.46% | 50.27% |
| pH | 6.41 | 6.24 | 6.47 |

Results of analysis using Rapid Visco Analyzer (viscosity) and Texture Analyzer (hardness) are shown in Table 8.

TABLE 8

| | | Viscosity (cP) @ |
|---|---|---|
| Product | Grams Hardness | 7 minutes |
| WPC | 5004.6 | 504.5 |
| HFWPC-R-1 | 3091.8 | 271.5 |
| HFWPC-R-2 | 3009.3 | 281.0 |

### Example 5—Hydrolyzed Pea Protein

Dried pea protein was hydrated at 15% solids for 30 minutes. The solution was heated to 165 degrees Fahrenheit for 15 seconds and homogenized at 3500 pounds per square inch (psi). Neutrase® (Novozymes Biopharma US Inc., Franklinton, N.C.) was added at 1% (w/w) of the total solids, and agitated for 2 hours while the temperature was maintained at 50 degrees Celsius. Microfiltration was performed using a membrane with a pore size of 500 kDa. The solution was first concentrated, then diafiltered with water to perform a 3× diafiltration. The permeate was collected as the hydrolyzed product (protein hydrolysate) and concentrated using nanofiltration. The retentate was collected as a high fat pea protein product. Amounts are shown below in Table 9.

TABLE 9

| | Protein dmb* (%) | Protein (grams) | % of total |
|---|---|---|---|
| Starting material | 84.7 | 1679 | 100 |
| MF permeate | 95.1 | 638.8 | 38 |
| MF retentate | 78.4 | 1040.2 | 62 |

*dmb—dry matter basis

### Example 6—Hydrolyzed Pea Protein

Dried pea protein was hydrated at 15% solids and adjusted to pH 8 using 50% NaOH. The pea protein solution was then heated to 50 degrees Celsius. Alcalase (Novozymes Biopharma US Inc., Franklinton, N.C.) was added at 0.5% (w/w) of the total solids, and agitated for 1 hour while the temperature was maintained at 50 degrees Celsius. Neutrase® (Novozymes Biopharma US Inc., Franklinton, N.C.) was then added at 0.5% (w/w) of the total solids, and agitated for 1 hour while the temperature was maintained at 50 degrees Celsius. The solution was heated to 165 degrees Fahrenheit for 15 seconds and homogenized at 3500 pounds per square inch (psi). Microfiltration was performed using a membrane with a pore size of 500 kDa. The solution was first concentrated, then diafiltered with water to perform a 3× diafiltration. The permeate was collected as the hydrolyzed product (protein hydrolysate) and concentrated using nanofiltration. The retentate was collected as a high fat pea protein product. Amounts are shown below in Table 10.

TABLE 10

| | Protein dmb* (%) | Protein (grams) | % of total |
|---|---|---|---|
| Starting material | 84.3 | 1390.5 | 100 |
| MF permeate | 95.9 | 690.6 | 49.7 |
| MF retentate | 72.9 | 699.9 | 50.3 |

*dmb—dry matter basis

What is claimed is:

1. A method for producing protein hydrolysates from high-fat protein concentrates, the method comprising the steps of:
(a) heating an about 5 to about 40 percent w/v solution of a high-fat protein concentrate starting material having a protein content of at least about 34 percent to a temperature of from about 90 to about 125 degrees Fahrenheit;
(b) hydrolyzing the protein, by adding at least one proteolytic enzyme to the solution, for a period of from about 1 hour to about 12 hours to produce a hydrolyzed protein; and
(c) isolating the hydrolyzed protein by filtering the solution to produce a permeate and a retentate, wherein the hydrolyzed protein is collected in the permeate as a protein hydrolysate.

2. The method of claim 1 further comprising the steps of
(d) hydrolyzing the protein remaining in the retentate using at least one proteolytic enzyme for a period of from about 1 to about 12 hours to produce a second hydrolyzed protein;
(e) isolating the second hydrolyzed protein by filtration to produce a second retentate and a second permeate, wherein a second hydrolyzed protein product is collected in the permeate as a second protein hydrolysate; and
(f) combining the first protein hydrolysate with the second protein hydrolysate, wherein the first protein hydrolysate is the hydrolysate produced in step (c).

3. The method of claim 1 wherein the solution is a solution of from about 13 to about 17 percent w/v.

4. The method of claim 1 further comprising the step of diafiltration to concentrate the hydrolyzed protein from the retentate from step (c).

5. The method of claim 1 further comprising the step of diafiltration to concentrate the hydrolyzed protein from the retentate from step (e).

6. The method of claim 1 wherein the protein is an animal protein.

7. The method of claim 1 wherein the protein is a plant protein.

8. The method of claim 1 wherein the protein is a milk-derived protein.

9. The method of claim 1 wherein the protein is whey protein.

10. The method of claim 1 wherein the protein is pea protein.

11. A method for producing whey protein hydrolysates from high-fat whey protein concentrates derived from the by-product retentate of the manufacture of whey protein isolates, the method comprising the steps of:
(a) hydrolyzing a first protein fraction in a high-fat whey protein concentrate using at least one proteolytic enzyme to produce a first hydrolyzed protein product;
(b) separating the first hydrolyzed protein product from the high-fat whey protein concentrate;
(c) hydrolyzing a second protein fraction which remained with the high-fat whey protein concentrate after the step of separating the first hydrolyzed protein product from the high-fat whey protein concentrate, using at least one proteolytic enzyme to produce a second hydrolyzed protein product; and
(d) separating the second hydrolyzed protein product from the high-fat whey protein concentrate.

12. The method of claim 11 further comprising a step (e) combining the first hydrolyzed protein product with the second hydrolyzed protein product.

13. A method for Isolating a milk fat globule membrane product from high-fat whey protein concentrates derived from the by-product retentate of the manufacture of whey protein isolates, the method comprising the steps of
(a) heating an about 5 to about 40 percent w/v solution of a high-fat whey protein concentrate having a protein content of at least about 34 percent to a temperature of from about 90 to about 125 degrees Fahrenheit;
(b) hydrolyzing the protein using at least one proteolytic enzyme for a period of from about 1 hour to about 12 hours; and
(c) isolating a milk fat globule membrane product by filtering the solution to produce a permeate and a retentate, wherein the milk fat globule membrane product is collected in the retentate.

14. The method of claim 13 further comprising repeating steps (b) and (c) using the retentate as a starting material.

15. A method for producing whey protein hydrolysates from high-fat whey protein concentrates and/or whey protein concentrates, the method comprising the steps of:
(a) heating an about 5 to about 40 percent w/v solution of a high-fat whey protein starting material having a protein content of at least about 34 percent to a temperature of from about 90 to about 125 degrees Fahrenheit;
(b) hydrolyzing the protein, by the adding to the solution at least one proteolytic enzyme, for a period of from about 1 hour to about 12 hours;
(c) isolating the hydrolyzed protein by filtering the solution to produce a permeate and a retentate, wherein the hydrolyzed protein is collected in the permeate as a first protein hydrolysate;
(d) hydrolyzing the protein remaining in the retentate by adding at least one proteolytic enzyme to the retentate and hydrolyzing for a period of from about 1 to about 12 hours to produce a second hydrolyzed protein product;
(e) isolating the second hydrolyzed protein product by filtering the retentate, wherein a second permeate produced thereby comprises a second protein hydrolysate.

16. The method of claim 15 further comprising the step of (f) combining the first protein hydrolysate with the second protein hydrolysate, the first protein hydrolysate being the protein hydrolysate of step (c).

17. The method of claim 15 wherein the solution is a solution of from about 13 to about 17 percent w/v.
